(19) United States
(12) Patent Application Publication
(10) Pub. No.: US 2025/0214771 A1
(43) Pub. Date: Jul. 3, 2025

(54) MATERIAL RACK FOR MECHANICAL LOADER

(71) Applicant: Ignacio Solis, Northfield, NH (US)

(72) Inventor: Ignacio Solis, Northfield, NH (US)

(21) Appl. No.: 19/002,118

(22) Filed: Dec. 26, 2024

Related U.S. Application Data
(60) Provisional application No. 63/616,565, filed on Dec. 30, 2023.

(51) Int. Cl. B65G 1/02

(52) U.S. Cl. CPC B65G 1/02

(57) ABSTRACT

A material rack configured to be connected to a mechanical material loader is disclosed. The material rack includes an upper horizontal member. The material rack further includes a lower horizontal member and one or more vertical frame members. The vertical frame members are attached to the upper horizontal member and the lower horizontal member. The material rack further includes a horizontal frame channel and one or more lower frame members. The lower frame members are attached to the lower horizontal member and the horizontal frame channel. The upper horizontal member, the lower horizontal member and the horizontal frame channel are aligned parallel to each other.

### TECHNICAL FIELD

The present disclosure relates generally to a material rack. More particularly, the present disclosure relates to a material rack attachable to a mechanical loader for transporting material via the mechanical loader. The material rack enables loading operation when the material rack is in a horizontal orientation and enables unloading operation when the material rack is in a vertical orientation, thereby minimizing the manual labor required for loading and unloading operations.

### BACKGROUND

Mechanical material loaders, such as lull loaders, telehandlers, etc., are extensively used in construction, agricultural, warehousing, logistics and industrial environments to load, unload and transport heavy goods across short distances. A mechanical material loader typically includes a crane and a forklift that is used to lift heavy goods off the ground to an optimal height from where the goods may be efficiently transported.

While the mechanical material loaders are immensely beneficial for operators to transport heavy goods, loading and unloading of the goods onto/from the material loaders are tedious tasks that require considerable manual effort. Furthermore, there are known instances of goods falling off the material loaders during transportation, when the goods are not safely secured on the loaders.

Some operators use conventional pallet or cantilever racks to transport goods by using the mechanical material loaders; however, loading and unloading of goods onto and from such racks are challenging tasks. In addition, such racks may not provide secure storage of the goods during transportation.

In light of the above, an apparatus is required that enables an operator to conveniently load, unload and transport heavy goods by using a mechanical material loader.

It is with respect to these and other considerations that the disclosure made herein is presented.

The statements in this section merely provide background information related to the present disclosure and do not constitute prior art.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a perspective view of a material rack in accordance with the present disclosure.

FIG. 3 depicts a front view of the material rack of FIG. 2 in accordance with the present disclosure.

FIG. 4 depicts a rear view of the material rack of FIG. 2 in accordance with the present disclosure.

FIG. 5 depicts a right side view of the material rack of FIG. 2 in accordance with the present disclosure.

FIG. 6 depicts a left side view of the material rack of FIG. 2 in accordance with the present disclosure.

FIG. 7 depicts a top view of the material rack of FIG. 2 in accordance with the present disclosure.

FIG. 8 depicts a bottom view of the material rack of FIG. 2 in accordance with the present disclosure.

FIG. 9 depicts a side view of the material rack of FIG. 2 in accordance with the present invention, illustrating a load of material placed on the material rack; the material rack is oriented in a vertical position on the forks of a mechanical material loader for transport and unloading operations.

### DETAILED DESCRIPTION

### Overview

The present disclosure describes a material rack configured to be attachable to and used with a mechanical material loader. The illustrated embodiments of a material rack include an upper horizontal member and one or more vertical member attachment bars. The vertical member attachment bars are attached to the upper horizontal member. In some embodiments, the material rack may not include the vertical member attachment bars. Stated another way, the presence of the vertical member attachment bars is not necessary for the structure of the material rack. The material rack further includes a lower horizontal member and one or more vertical frame members. The vertical frame members are attached to the vertical member attachment bars and the lower horizontal member. If the material rack does not include the vertical member attachment bars, the vertical frame members may be attached to or between the upper horizontal member and the lower horizontal member. The material rack further includes a horizontal frame channel and one or more lower frame members. The lower frame members are attached to the lower horizontal member and the horizontal frame channel. In some embodiments, the upper horizontal member, the lower horizontal member and the horizontal frame channel (specifically their longitudinal axes) are aligned parallel to each other.

In certain embodiments, the vertical member attachment bars include a first vertical member attachment bar and a second vertical member attachment bar. The first vertical member attachment bar is attached to a proximal portion of the upper horizontal member, and the second vertical member attachment bar is attached to a distal portion of the upper horizontal member.

In some embodiments, the vertical frame members include a first interior vertical frame member and a second interior vertical frame member. Longitudinal axes of the first interior vertical frame member and the second interior vertical frame member are perpendicular to a longitudinal axis of the lower horizontal member.

The material rack further includes one or more anterior vertical frame members. In certain embodiments, the anterior vertical frame members include a first anterior vertical frame member and a second anterior vertical frame member. The first and second anterior vertical frame members are disposed parallel to the first interior vertical frame member and the second interior vertical frame member. In some embodiments, the first anterior vertical frame member and the second anterior vertical frame member are attached to the vertical member attachment bars and the lower frame members. Further, the lengths of the anterior vertical frame members are equivalent to the lengths of the interior vertical frame members. If the material rack does not include the vertical member attachment bars, the first anterior vertical frame member and the second anterior vertical frame member may be attached to the upper horizontal member and the lower frame members.

The material rack further includes one or more loader fork receptacle tubes attached to the horizontal frame channel and the lower horizontal member. In certain embodiments, the loader fork receptacle tubes include a first loader fork receptacle tube and a second loader fork receptacle tube. The loader fork receptacle tubes include openings disposed at those edges of the loader fork receptacle tubes that are attached to the horizontal frame channel. The openings are configured to receive forks of the mechanical material loader.

The material rack further includes one or more diagonal braces attached to the upper horizontal member and the loader fork receptacle tubes. In certain embodiments, the diagonal braces include a first diagonal brace and a second diagonal brace. The diagonal braces are attached to those edges of the loader fork receptacle tubes that are away from the openings.

The material rack further includes one or more fork chain attachment bracket eyes attached to the loader fork receptacle tubes. The fork chain attachment bracket eyes are configured to removably attach to one or more fork attachment chains that secure the material rack to the mechanical material loader.

In some embodiments, the material rack further includes one or more loader fork tensioning bolts attached to the loader fork receptacle tubes. The loader fork tensioning bolts are configured to securely retain the forks of the mechanical material loader in the loader fork receptacle tubes.

The material rack further includes one or more material retention chain eyelets attached to the vertical member attachment bars. If the material rack does not include the vertical member attachment bars, the material retention chain eyelets may be attached to the upper horizontal member. The material retention chain eyelets are configured to receive and attach one end of a material retention chain used to secure goods on the material rack.

In some embodiments, the material rack is oriented in a horizontal position when the vertical frame members are oriented substantially parallel to ground, and the material rack is oriented in a vertical position when the vertical frame members are oriented substantially perpendicular to the ground.

The material rack may enable an operator to conveniently load the goods onto the material rack when the material rack is oriented in the horizontal position. Further, the operator may conveniently transport the goods on the material rack via the mechanical material loader and/or unload the goods from the material rack when the material rack is oriented in the vertical position. The material rack may be conveniently attached to and detached from the mechanical material loader. Further, the material rack can withstand weight of heavy loads, thereby enabling the operator to conveniently load heavy goods onto the material rack, without having to worry about breakage.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

Detailed illustrative descriptions of example embodiments are disclosed herein. However, specific structural and functional details disclosed herein are merely representative for purposes of describing example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”; “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprise”, “comprises”, “comprising,”, “include”, “includes” and/or “including”, when used herein, specify the presence of stated features, integers, steps, operations, elements, and/or components, but do not preclude the presence or addition of one or more other features, integers, steps, operations, elements, components, and/or groups thereof.

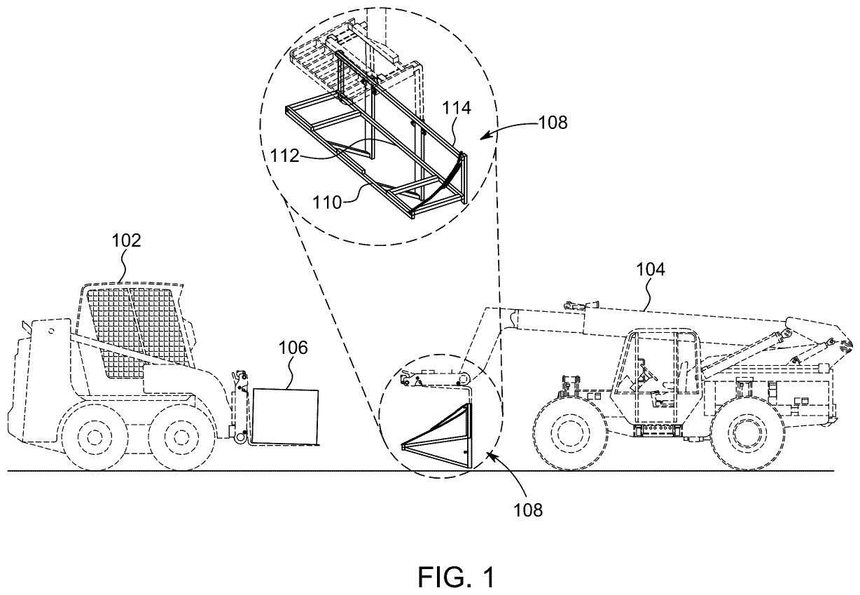

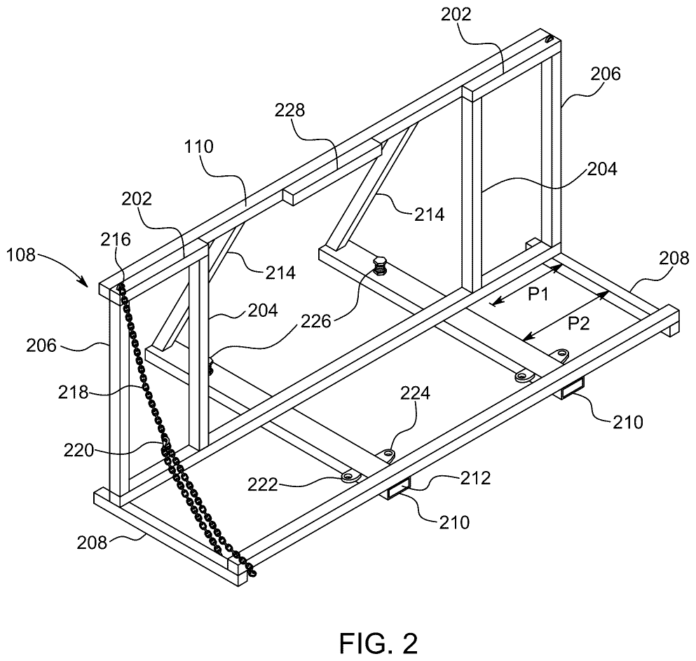

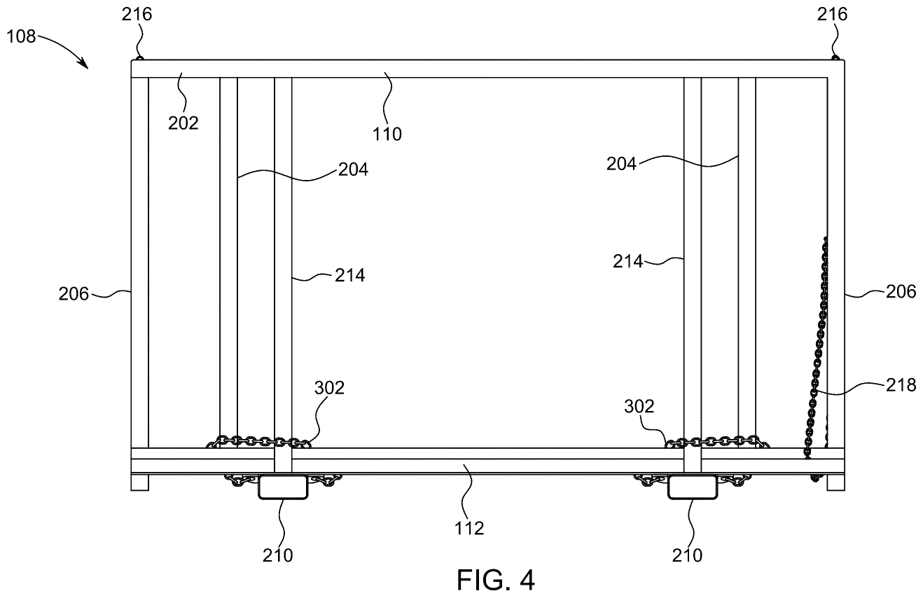

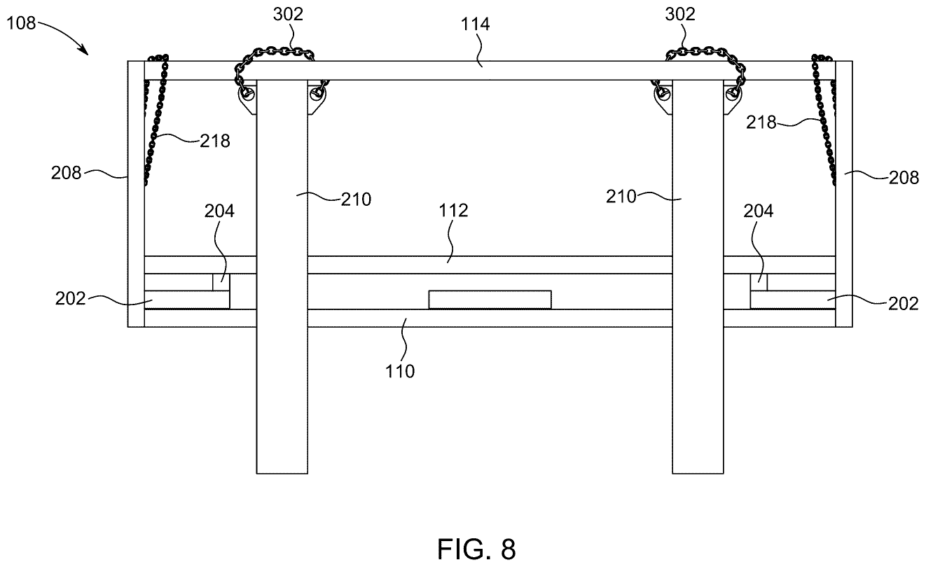

FIG. 1 depicts an example environment 100 in which techniques and structures for providing the systems and methods disclosed herein may be implemented. FIG. 1 will be described in conjunction with FIGS. 2-9. The environment 100 may include a skid steer loader 102 and a mechanical material loader 104 (e.g., a lull loader or a telehandler). The skid steer loader 102 may load or unload heavy goods 106 (e.g., sheet materials, building material, etc.) onto or from the mechanical material loader 104. The mechanical material loader 104 may secure/store and transport the goods 106 received from the skid steer loader 102. FIG. 1 depicts an example construction environment; however, the present disclosure is not limited to only the construction application area. The present disclosure may be applied to other environments such as agricultural, warehousing, logistics, and/or the like, or any other environment that requires loading, unloading and transportation of heavy goods. Consequently, the example environment 100 depicted in FIG. 1 should not be construed as limiting. The loaders 102 and 104 are shown in broken lines as the loaders are presented in the figures for explanatory purposes only and form no part of the claimed subject matter.

The environment 100 may further include a material rack 108 that may be connected/attached to the mechanical material loader 104, and may receive the goods 106 from the skid steer loader 102. The material rack 108 may provide a secure storage for the goods 106, and may enable an operator (not shown) to conveniently load and onload the goods 106 onto and from the material rack 108 (and hence onto and from the mechanical material loader 104) and securely transport the goods 106 via the mechanical material loader 104. The material rack 108 minimizes the risk of the goods 106 falling off the mechanical material loader 104 when the mechanical material loader 104 may be transporting the goods 106. Furthermore, the material rack 108 considerably minimizes the manual effort required to load and unload the goods 106 onto and from the mechanical material loader 104, as described in the description below.

FIG. 1 depicts the material rack 108 in a horizontal orientation, and FIGS. 2-9 depict the material rack 108 in a vertical orientation. In some aspects, the material rack 108 may be configured to receive the goods 106 when the material rack 108 is oriented in the horizontal orientation, and the mechanical material loader 104 may efficiently store and transport (and/or unload) the goods 106 when the material rack 108 is oriented in the vertical orientation. Consequently, the operator may move (via the mechanical material loader 104) the material rack 108 to the horizontal orientation when the operator desires to load the goods 106 onto the material rack 108 (as shown in FIG. 1), and may move the material rack 108 to the vertical orientation when the operator desires to transport the goods 106 or unload the goods 106 from the material rack 108.

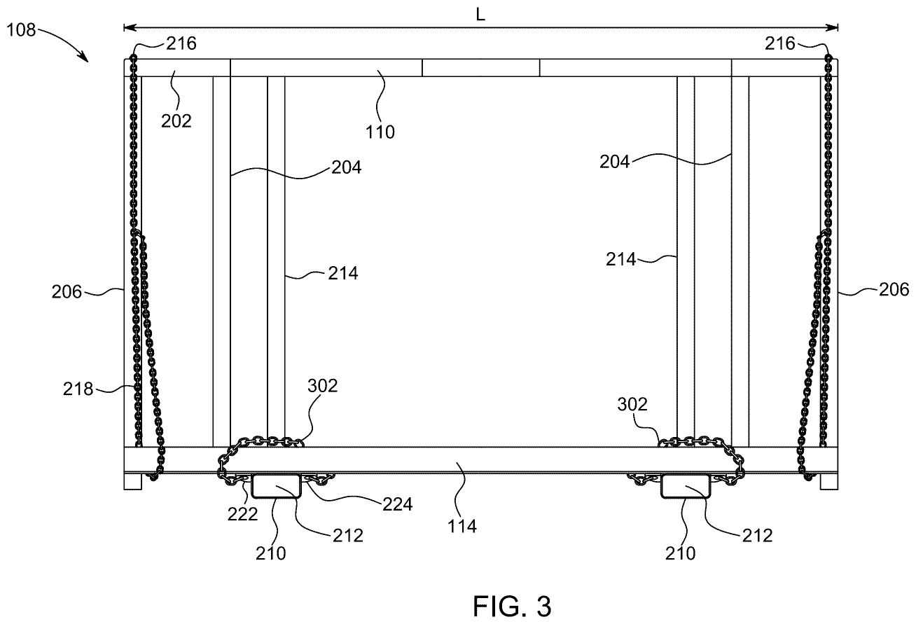

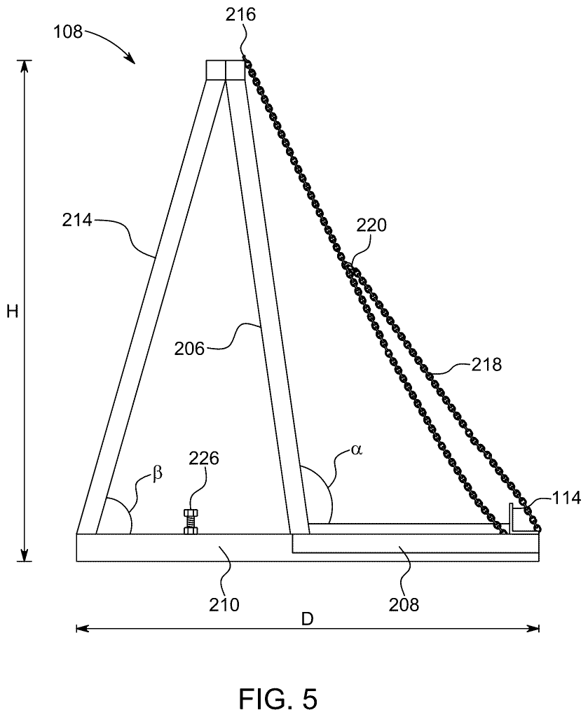

The material rack 108 may include a plurality of components including, but not limited to, an upper horizontal member 110, a lower horizontal member 112 and a horizontal frame channel 114 (as shown in FIGS. 1 and 2). Each of the upper horizontal member 110, the lower horizontal member 112 and the horizontal frame channel 114 may be shaped as cuboidal rods (or may be cylindrical rods) that may be hollow or solid, and may be made of metal such as iron, aluminum, etc. Further, each of the upper horizontal member 110, the lower horizontal member 112 and the horizontal frame channel 114 may have a length “L” (shown in FIG. 3) in a range of 6 to 8 feet. Stated another way, the length “L” of the material rack 108 may be in a range of 6 to 8 feet. Furthermore, a distance “H” between the upper horizontal member 110 and the lower horizontal member 112 (i.e., the height “H” of the material rack 108, shown in FIG. 5) may be in a range of 3 to 5 feet. In additional aspects, a depth “D” of the material rack 108 (shown in FIG. 5) may also be in a range of 3 to 5 feet.

The dimensions described above are exemplary in nature and should not be construed as limiting. The material rack 108 may have other dimensions, different from the ones described above, without departing from the scope of the present disclosure.

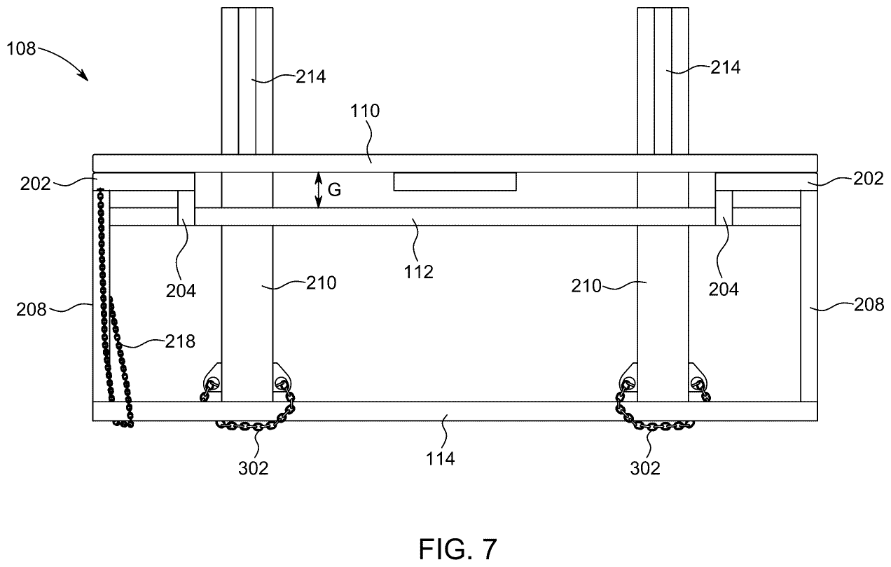

The upper horizontal member 110, the lower horizontal member 112 and the horizontal frame channel 114 may have equivalent dimensions and may be oriented parallel to each other. In an exemplary aspect, a predefined gap “G” (shown in FIG. 7) may exist in the alignment of the upper and lower horizontal members 110, 112, when the material rack 108 may be positioned in the vertical orientation. In some aspects, the upper and lower horizontal members 110, 112 may be parallel and substantially equidistant from the ground when the material rack 108 may be positioned in the horizontal orientation (as shown in FIG. 1), and the lower horizontal member 112 and the horizontal frame channel 114 may be parallel and substantially equidistant from the ground when the material rack 108 may be positioned in the vertical orientation.

The material rack 108 may further include a plurality of vertical member attachment bars 202 (e.g., a first vertical member attachment bar and a second vertical member attachment bar, as shown in FIG. 2) that may be directly attached to proximal and distal portions/ends (or first and second portions/ends) of the upper horizontal member 110. The presence of the vertical member attachment bars 202 is not necessary for the structure of the material rack 108. If the material rack 108 does not include the vertical member attachment bars 202, all the functions of the vertical member attachment bars 202 described below may be performed directly by the upper horizontal member 110.

In some aspects, a length of each vertical member attachment bar 202 may be equal, and may be in a range of 0.5 to 1.5 feet. The vertical member attachment bars 202 may have the same shape as the upper horizontal member 110 and may be made of the same material. Further, the vertical member attachment bars 202 may be directly attached to the upper horizontal member 110 such that their longitudinal axes are parallel to the longitudinal axis of the upper horizontal member 110.

The material rack 108 may further include a plurality of interior vertical frame members 204 (e.g., a first interior vertical frame member and a second interior vertical frame member) that may be directly attached to the vertical member attachment bars 202 and the lower horizontal member 112. Specifically, a top end of each interior vertical frame member 204 may be attached to the vertical member attachment bar 202 and a bottom end of the interior vertical frame member 204 may be attached to the lower horizontal member 112, as shown in FIG. 2. The longitudinal axes of the interior vertical frame members 204 may be perpendicular to the longitudinal axes of the upper horizontal member 110, the lower horizontal member 112 and the horizontal frame channel 114.

Since the vertical member attachment bars 202 are attached to the upper horizontal member 110, and the interior vertical frame members 204 are attached to the vertical member attachment bars 202 and the lower horizontal member 112, it may be appreciated that the interior vertical frame members 204 are attached between the upper and lower horizontal members 110, 112.

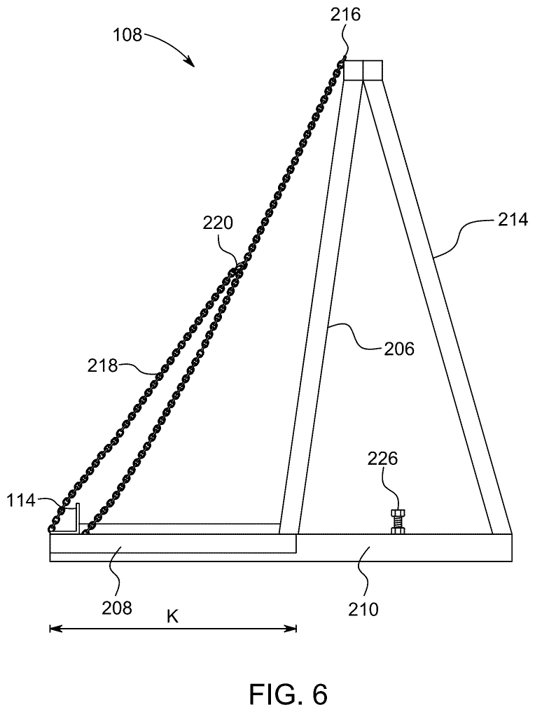

The material rack 108 may further include a plurality of exterior or anterior vertical frame members 206 (e.g., a first anterior vertical frame member and a second anterior vertical frame member) that may be directly attached to the vertical member attachment bars 202. Specifically, a top end of each anterior vertical frame member 206 may be attached to the vertical member attachment bar 202 and a bottom end of each anterior vertical frame member 206 may be attached to a lower frame member 208, as shown in FIG. 2. The lower frame members 208 may be attached to and between the lower horizontal member 112 and the horizontal frame channel 114. Specifically, a proximal end of the lower horizontal member 112 may be attached to a distal end of a first lower frame member 208, and a proximal end of the horizontal frame channel 114 may be attached to a proximal end of the first lower frame member 208. Similarly, a distal end of the lower horizontal member 112 may be attached to a distal end of a second lower frame member 208, and a distal end of the horizontal frame channel 114 may be attached to a proximal end of the second lower frame member 208. In this manner, the first and second lower frame members 208 may be attached between the lower horizontal member 112 and the horizontal frame channel 114. In an exemplary aspect, the lower frame members 208 may have a length “K” (shown in FIG. 6) that may be in a range of 2 to 3 feet.

It may be appreciated from the description above that the interior vertical frame members 204 and the anterior vertical frame members 206 are attached (directly or indirectly) to and between the upper and lower horizontal members 110, 112. The distance between the interior and anterior vertical frame members 204, 206 may be substantially equivalent to the length of the vertical member attachment bar 202. The interior and anterior vertical frame members 204, 206 may be aligned parallel to each other, and may be disposed at a predefined angle “α” (shown in FIG. 5) relative to the longitudinal axes of the lower frame members 208. The angle “α” may be in a range of about 90 to 120 degrees. Such an alignment of the interior and anterior vertical frame members 204, 206 relative to the lower frame members 208 enables efficient loading and unloading operation of the goods 106 to and from the material rack 108, and also enables secure storage of the goods 106 on the material rack 108 during transportation. In one embodiment, the angle “α” may be about 90 degrees wherein the material rack 108 is of sturdy construction and the angular orientation of any goods 106 during loading, unloading or transport, can be controlled by an operator of the loader 104.

The presence and arrangement of the interior vertical frame members 204 and the anterior vertical frame members 206 in the material rack 108, as described above, enhances the structural integrity of the material rack 108. Further, the interior vertical frame members 204 and the anterior vertical frame members 206 enable the material rack 108 to efficiently receive/load heavy goods. For example, the operator may load/place big and heavy goods (e.g., the goods 106) on the interior and anterior vertical frame members 204 when the material rack 108 may be in the horizontal position, to conveniently load the goods 106 onto the material rack 108, as shown in FIG. 1. The interior and anterior vertical frame members 204 may be solid rods made of metal (e.g., iron, aluminum, etc.) that can withstand the weight of the goods 106.

The material rack 108 may further include a plurality of loader fork receptacle tubes 210 (e.g., a first loader fork receptacle tube 210 and a second loader fork receptacle tube 210) that is directly attached to the horizontal frame channel 114 and the lower horizontal member 112 (as shown in FIG. 2). Each loader fork receptacle tube 210 may have a length equivalent to the depth “D” and may be shaped as a hollow and flattened cuboidal bar. In an exemplary aspect, the loader fork receptacle tubes 210 may be attached to the undersides of the horizontal frame channel 114 and the lower horizontal member 112, as shown in FIG. 2.

The edges of the loader fork receptacle tubes 210 that are attached to the horizontal frame channel 114 may include openings 212 (as shown in FIGS. 2 and 3) that may be configured to receive the forks of the mechanical material loader 104. Specifically, to attach the mechanical material loader 104 with the material rack 108, the operator may insert the forks of the mechanical material loader 104 into the loader fork receptacle tubes 210 via the openings 212. The dimensions of the openings 212 and the width/height of the loader fork receptacle tubes 210 may correspond to the dimensions of conventional forks of a mechanical material loader, so that the loader fork receptacle tubes 210 may efficiently and conveniently receive the forks of the mechanical material loader 104. Once the forks are inside the loader fork receptacle tubes 210, the operator may conveniently move the material rack 108 between the horizontal and vertical positions, and transport the goods 106 on the material rack 108 via the mechanical material loader 104. In this manner, the loader fork receptacle tubes 210 serve to house the forks of the mechanical material loader 104 during loading, transport, and unloading operations.

In some aspects, the openings 212 may be disposed closer to the center of the horizontal frame channel 114, than the interior vertical frame members 204. Specifically, the interior vertical frame members 204 may be disposed at a distance “P1” from the lower frame member 208, and the loader fork receptacle tubes 210 may be disposed at a distance “P2” from the lower frame member 208, as shown in FIG. 2. The distance “P2” may be greater than the distance “P1”, and therefore the loader fork receptacle tubes 210 (and hence the openings 212) may be disposed closer to the center of the horizontal frame channel 114 than the interior vertical frame members 204. Such an arrangement of the loader fork receptacle tubes 210 in the material rack 108 enables the mechanical material loader 104 to stably and securely attach the material rack 108 to the forks of the mechanical material loader 104, and ensures that the material rack 108 does not topple or tilt towards left or right during the transportation operation.

The material rack 108 may further include a plurality of diagonal braces 214 (e.g., a first diagonal brace 214 and a second diagonal brace 214) that may be attached to and between the upper horizontal member 110 and those ends of the loader fork receptacle tube 210 that are away from the openings 212. Specifically, a top end of each diagonal brace 214 may be attached to the upper horizontal member 110 and a bottom end of each diagonal brace 214 may be attached to that end of the loader fork receptacle tube 210 that is away from the opening 212.

The diagonal braces 214 may be attached to the loader fork receptacle tubes 210 and the upper horizontal member 110 such that the diagonal braces 214 are aligned at a predefined angle “β” relative to the loader fork receptacle tubes 210, as shown in FIG. 5. The angle “β” may be in a range of 60 to 80 degrees. Such an arrangement of the diagonal braces 214 (and the arrangement of the interior and anterior vertical frame members 204, 206) in the material rack 108 enables the material rack 108 to securely receive heavy goods from the skid steer loader 102, when the material rack 108 may be in the horizontal position and the operator may be loading the heavy goods (e.g., the goods 106) onto the material rack 108. Specifically, the arrangements of the diagonal braces 214 and the interior and anterior vertical frame members 204, 206, as described above, ensure that the weight of the goods 106 is distributed amongst the interior and anterior vertical frame members 204, 206 and the loader fork receptacle tubes 210 (that house the forks of the mechanical material loader 104), when the operator loads the goods 106 onto the material rack 108 in the horizontal position.

The material rack 108 may additionally include a plurality of material retention chain eyelets 216 (e.g., a first material retention chain eyelet and a second material retention chain eyelet) that may be directly attached to the vertical member attachment bars 202. The material retention chain eyelet 216 may be configured to receive and attach one end (e.g., a top end) of a material retention chain Fi that may be used to secure the goods 106 on the material rack 108, when the goods 106 may be placed on the material rack 108. As an example, the operator may first place the goods 106 on the material rack 108, and then attach the top end of the material retention chain 218 to the material retention chain eyelet 216. The operator may further secure the goods 106 on the material rack 108 by wrapping the material retention chain 218 around the horizontal frame channel 114. The operator may finally removably attach the other end (e.g., the bottom end) of the material retention chain 218 by using a clevis hook 220 (or any other type of hook or fastening means). In an alternative embodiment (not shown in FIG. 2), a second material retention chain 218 may be attached to a second material retention chain eyelet 216 fixed to the second vertical member attachment bar 202 to further secure the goods 106 on the material rack 108.

In certain embodiments, the material rack 108 may further include a plurality of upwardly angled fork chain attachment bracket eyes 222 (or first upwardly angled fork chain attachment bracket eyes and second upwardly angled fork chain attachment bracket eyes) attached to one side of the loader fork receptacle tubes 210. The material rack 108 may further include a plurality of downwardly angled fork chain attachment bracket eyes 224 (or first downwardly angled fork chain attachment bracket eyes and second downwardly angled fork chain attachment bracket eyes) attached to an opposing side of the loader fork receptacle tubes 210. The operator may removably attach first and second fork attachment chains 302 (shown in FIGS. 3, 4, 7 and 8) to the fork chain attachment bracket eyes 222, 224 to secure the material rack 108 to a material loader fork attachment of the mechanical material loader 104 during the goods loading operation.

The material rack 108 may further include a plurality of loader fork tensioning bolts 226 attached to the upper surface of each loader fork receptacle tube 210 for safely and securely retaining the forks of the mechanical material loader 104 in the loader fork receptacle tube 210, especially when the forks are oriented in the vertical downward position (as shown in FIG. 1) during the goods loading operation. In an exemplary aspect, the loader fork tensioning bolts 226 may be equidistant from the bottom end of each diagonal brace 214 and the lower horizontal member 112.

In some embodiments, the material rack 108 may further include an additional support bar 228 that may be similar in shape and dimensions to the vertical member attachment bars 202. The support bar 228 may be attached to a center portion of the upper horizontal member 110, and may ensure that the goods 106 do not slip off the material rack 108 during the goods loading operation.

During operation, the operator may first load the goods 106 on the skid steer loader 102. The operator may then move the skid steer loader 102 to be in proximity to the mechanical material loader 104. The operator may additionally attach the material rack 108 to the forks of the mechanical material loader 104 by sliding the forks into the loader fork receptacle tubes 210 via the openings 212. The operator may further secure the forks via the of loader fork tensioning bolts 226.

The operator may then rotate the forks of the mechanical material loader 104 in the vertical downward position so that the material rack 108 may be oriented in the horizontal position, as shown in FIG. 1. In an exemplary aspect, the interior and anterior vertical frame members 204, 206 may be oriented substantially parallel to the ground when the material rack 108 is oriented in the horizontal position.

Responsive to the material rack 108 being oriented in the horizontal position, the operator may transfer the goods 106 from the skid steer loader 102 onto the material rack 108. Stated another way, the operator may load the goods 106 from the skid steer loader 102 onto the interior and anterior vertical frame members 204, 206 when the material rack 108 is oriented in the horizontal position.

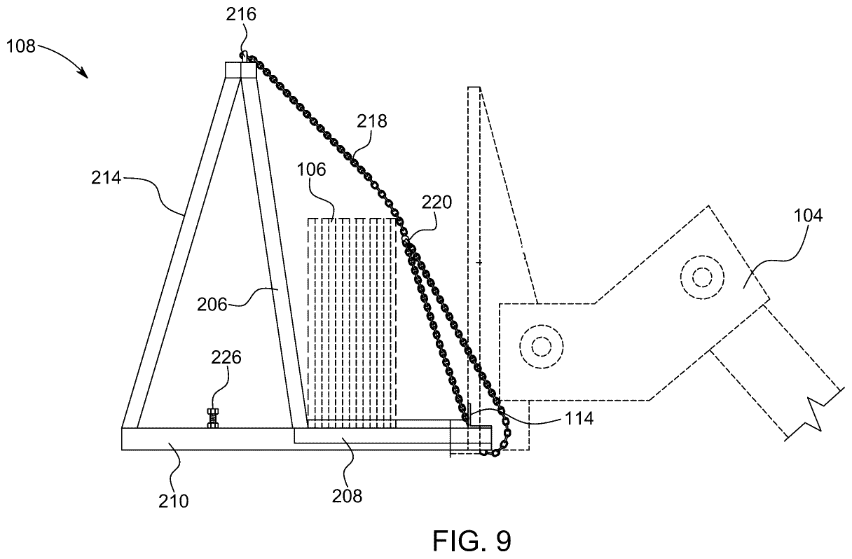

In some aspects, the operator may then secure the goods 106 on the material rack 108 (i.e., on the interior and anterior vertical frame members 204, 206) by using the material retention chain(s) 218 and the material retention chain eyelet(s) 216, as described above. The operator may then rotate the forks of the mechanical material loader 104 in the horizontal position (parallel to the ground) so that the material rack 108 may be oriented in the vertical position, as shown in FIG. 9. In an exemplary aspect, the loader fork receptacle tubes 210 may be disposed parallel to the ground and the interior and anterior vertical frame members 204, 206 may be disposed approximately perpendicular (e.g., close to 75-80 degrees relative) to the ground when the material rack 108 is oriented in the vertical position. The goods 106 may be securely stored on the material rack 108 when the material rack 108 is oriented in the vertical position. Further, the weight of the goods 106 may be on the lower frame members 208 and the loader fork receptacle tubes 210 when the material rack 108 is oriented in the vertical position. As shown in FIG. 9, when the goods 106 including sheet materials are positioned on the material rack 108, the angular disposition (angle “α” shown in the Figures) may allow the sheet material to rest at an angle against the vertical frame members 204, 206 for stability during transport.

The operator may transport the goods 106 to their desired destination by using the mechanical material loader 104 when the material rack 108 is oriented in the vertical position. The interior and anterior vertical frame members 204, 206 ensure that the goods 106 do not topple off the material rack 108 when the goods 106 are being transported. Referring to FIG. 9, once at the desired destination, a person can unload the goods 106, especially sheet materials, when the goods are presented in a vertical position as opposed to the goods being stacked one on top of the other. Alternatively, once at a delivery destination, the operator may again rotate the forks of the mechanical material loader 104 in the vertical downward position so that the material rack 108 may be oriented in the horizontal position, to enable unloading of the goods 106 from the material rack 108. In this manner, the material rack 108 enables efficient loading, transportation and unloading of the goods 106, with minimal manual effort.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

It is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A material rack comprising:
an upper horizontal member;
a lower horizontal member and one or more vertical frame members, wherein the one or more vertical frame members are attached to the upper horizontal member and the lower horizontal member; and
a horizontal frame channel and one or more lower frame members, wherein the one or more lower frame members are attached to the lower horizontal member and the horizontal frame channel, and
wherein the upper horizontal member, the lower horizontal member and the horizontal frame channel are aligned parallel to each other.

2. The material rack of claim 1 further comprising one or more vertical member attachment bars, wherein the one or more vertical member attachment bars are attached to the upper horizontal member.

3. The material rack of claim 2, wherein the one or more vertical member attachment bars comprise a first vertical member attachment bar and a second vertical member attachment bar, wherein the first vertical member attachment bar is attached to a proximal portion of the upper horizontal member, and wherein the second vertical member attachment bar is attached to a distal portion of the upper horizontal member.

4. The material rack of claim 1, wherein the one or more vertical frame members comprise a first interior vertical frame member and a second interior vertical frame member, and wherein longitudinal axes of the first interior vertical frame member and the second interior vertical frame member are perpendicular to a longitudinal axis of the lower horizontal member.

5. The material rack of claim 4 further comprising one or more anterior vertical frame members.

6. The material rack of claim 5, wherein the one or more anterior vertical frame members are disposed parallel to the first interior vertical frame member and the second interior vertical frame member.

7. The material rack of claim 5, wherein the one or more anterior vertical frame members comprise a first anterior vertical frame member and a second anterior vertical frame member.

8. The material rack of claim 7, wherein the first anterior vertical frame member and the second anterior vertical frame member are attached to the upper horizontal member and the one or more lower frame members.

9. The material rack of claim 5, wherein lengths of the one or more anterior vertical frame members are equivalent to lengths of the one or more vertical frame members.

10. The material rack of claim 1 further comprising one or more loader fork receptacle tubes attached to the horizontal frame channel and the lower horizontal member.

11. The material rack of claim 10, wherein the one or more loader fork receptacle tubes comprise a first loader fork receptacle tube and a second loader fork receptacle tube.

12. The material rack of claim 10, wherein the one or more loader fork receptacle tubes comprise openings disposed at edges of the one or more loader fork receptacle tubes that are attached to the horizontal frame channel, and wherein the openings are configured to receive forks of a mechanical material loader.

13. The material rack of claim 12 further comprising one or more diagonal braces attached to the upper horizontal member and the one or more loader fork receptacle tubes.

14. The material rack of claim 13, wherein the one or more diagonal braces are attached to those edges of the one or more loader fork receptacle tubes that are away from the openings.

15. The material rack of claim 12 further comprising one or more fork chain attachment bracket eyes attached to the one or more loader fork receptacle tubes, wherein the one or more fork chain attachment bracket eyes are configured to removably attach to one or more fork attachment chains that secure the material rack to the mechanical material loader.

16. The material rack of claim 12 further comprising one or more loader fork tensioning bolts attached to the one or more loader fork receptacle tubes, wherein the one or more loader fork tensioning bolts are configured to securely retain the forks of the mechanical material loader in the one or more loader fork receptacle tubes.

17. The material rack of claim 1 further comprising one or more material retention chain eyelets attached to the upper horizontal member, wherein the one or more material retention chain eyelets are configured to receive and attach one end of a material retention chain used to secure goods on the material rack.

18. The material rack of claim 1, wherein the material rack is oriented in a horizontal position when the one or more vertical frame members are oriented substantially parallel to ground, and wherein the material rack is oriented in a vertical position when the one or more vertical frame members are oriented substantially perpendicular to the ground.

19. A material rack comprising:
an upper horizontal member and one or more vertical member attachment bars, wherein the one or more vertical member attachment bars are attached to the upper horizontal member;
a lower horizontal member and one or more vertical frame members, wherein the one or more vertical frame members are attached to the one or more vertical member attachment bars and the lower horizontal member;
a horizontal frame channel and one or more lower frame members, wherein the one or more lower frame members are attached to the lower horizontal member and the horizontal frame channel, and wherein the upper horizontal member, the lower horizontal member and the horizontal frame channel are aligned parallel to each other; and
one or more loader fork receptacle tubes attached to the horizontal frame channel and the lower horizontal member, wherein the one or more loader fork receptacle tubes comprise openings disposed at edges of the one or more loader fork receptacle tubes that are attached to the horizontal frame channel, and wherein the openings are configured to receive forks of a mechanical material loader.

20. A material rack comprising:
an upper horizontal member and one or more vertical member attachment bars, wherein the one or more vertical member attachment bars are attached to the upper horizontal member;
a lower horizontal member and one or more vertical frame members, wherein the one or more vertical frame members are attached to the one or more vertical member attachment bars and the lower horizontal member;
a horizontal frame channel and one or more lower frame members, wherein the one or more lower frame members are attached to the lower horizontal member and the horizontal frame channel, and wherein the upper horizontal member, the lower horizontal member and the horizontal frame channel are aligned parallel to each other;
one or more loader fork receptacle tubes attached to the horizontal frame channel and the lower horizontal member, wherein the one or more loader fork receptacle tubes comprise openings disposed at edges of the one or more loader fork receptacle tubes that are attached to the horizontal frame channel, and wherein the openings are configured to receive forks of a mechanical material loader; and
one or more diagonal braces attached to the upper horizontal member and the one or more loader fork receptacle tubes.
